(19) United States
(12) Patent Application Publication
(10) Pub. No.: US 2021/0262398 A1
(43) Pub. Date: Aug. 26, 2021

(54) GAS TURBINE ENGINE STALL MARGIN MANAGEMENT

(71) Applicant: General Electric Company, Schenectady, NY (US)

(72) Inventors: Paul Robert Gemin, Cincinnati, OH (US); Sridhar Adibhatla, Glendale, OH (US); Arthur Vorwerk Radun, Mason, OH (US); Kevin Richard Leamy, Loveland, OH (US)

(21) Appl. No.: 17/317,199

(22) Filed: May 11, 2021

Related U.S. Application Data
(63) Continuation of application No. 14/826,482, filed on Aug. 14, 2015.

(51) Int. Cl. F02C 7/36; F02C 7/26; F02C 9/56; F02C 7/32; B64D 27/10; F02C 3/04; F02C 7/268; H02P 9/00

(52) U.S. Cl. CPC F02C 7/36; F05D 2270/20; F02C 9/56; F02C 7/32; B64D 27/10; F02C 3/04; F02C 7/268; H02P 9/008; F05D 2220/323; F05D 2220/76; F05D 2260/85; F05D 2270/101; F05D 2270/04; F05D 2220/50; Y02T 50/60; F05D 2260/42; F05D 2270/051; F02C 7/26

(57) ABSTRACT

A method for operating a gas turbine engine having a starter-electric generator driven by one of a plurality of shafts of the gas turbine engine is provided. The method includes determining a desired amount of thrust to be produced by the gas turbine engine, as well as a desired amount of electrical power to be generated by the starter-electric generator of the gas turbine engine. The method operates the gas turbine engine to produce the desired amount of thrust, while producing less than the desired amount of electrical power using the starter-electric generator. Producing less than the desired amount of electrical power using the starter-electric generator allows for the desired amount of thrust production, or allows for the desired amount of thrust production more quickly.

### FIELD OF THE INVENTION

The present subject matter relates generally to a gas turbine engine and a method for operating the same.

### BACKGROUND OF THE INVENTION

A gas turbine engine generally includes a fan and a core arranged in flow communication with one another. Additionally, the core of certain gas turbine engines can include, in serial flow order, a compressor section (including a low pressure (LP) compressor and a high pressure (HP) compressor), a combustion section, a turbine section (including a high pressure (HP) turbine and a low pressure (LP) turbine), and an exhaust section. In operation, air from the fan is progressively compressed by the LP compressor and HP compressor until the air reaches the combustion section. Fuel is mixed with the compressed air and burned within the combustion section to provide combustion gases. The combustion gases are routed from the combustion section through the HP turbine and the LP turbine, and subsequently routed through the exhaust section, e.g., to atmosphere. The flow of combustion gasses through the HP turbine and LP turbine drives the HP turbine and LP turbine, respectively.

The HP turbine can be mechanically coupled to the HP compressor through a high pressure (HP) shaft, such that rotation of the HP turbine correspondingly rotates the HP compressor. Similarly, the LP turbine can be mechanically coupled to the LP compressor through a low pressure (LP) shaft, such that rotation of the LP turbine correspondingly rotates the LP compressor. Accordingly, the HP turbine can drive the HP compressor and the LP turbine can drive the LP compressor.

Additionally, rotation of the HP turbine can also drive various accessory systems of the gas turbine engine and/or an aircraft including the gas turbine engine. For example, the HP shaft in certain gas turbine engines drives an accessory gear box, which is mechanically coupled to a starter-electric generator. The starter-electrical generator extracts mechanical work from the HP shaft and transforms such work into electrical power for systems such as an environmental controls system of the aircraft including the gas turbine engine.

In order to ensure a stable air flow through the gas turbine engine and protect the gas turbine engine from stalling, the gas turbine engine is designed to operate within a stall margin calculated assuming a relatively high power extraction from the gas turbine engine using the starter-electric generator. However, such may result in, e.g., a relatively slow acceleration of the gas turbine engine and/or a decreased maximum available thrust production. Accordingly, a method for operating the gas turbine engine to improve a performance of the gas turbine engine despite a desired amount of electrical power to be generated from the starter-electric generator of the gas turbine engine would be particularly beneficial.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure a method for operating a multi-shaft aeronautical gas turbine engine having an electrical machine is provided. The electrical machine includes a starter-electric generator driven by at least one of the shafts of the gas turbine engine. The method includes determining a desired amount of thrust to be produced from the gas turbine engine, and determining a desired amount of electrical power to be generated from the starter-electric generator of the gas turbine engine. The method also includes producing the desired amount of thrust using the gas turbine engine, and producing less than the desired amount of electrical power using the starter-electric generator of the gas turbine engine to allow the gas turbine engine to produce the desired amount of thrust or produce the desired amount of thrust more quickly.

In an exemplary embodiment of the present disclosure an aeronautical gas turbine engine is provided. The gas turbine engine includes a compressor section, a combustion section located downstream of the compressor section, and a turbine section located downstream of the combustion section. The turbine section is mechanically coupled to the compressor section by one or more shafts. The gas turbine engine also includes an electrical machine in mechanical communication with the one or more shafts, the electrical machine including a starter-electric generator for generating electrical power. The gas turbine engine also includes a controller operably connected to the starter-electric generator. The controller is configured to reduce an amount of electrical power generated by the starter-electric generator to an amount below a desired amount in order to facilitate a desired amount of thrust production by the gas turbine engine or to facilitate the desired amount of thrust production by the gas turbine engine more quickly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross-sectional view of an exemplary gas turbine engine according to various embodiments of the present subject matter.

FIG. 2 is a simplified, schematic view of the exemplary gas turbine engine of FIG. 1 including aspects of a power management system in accordance with an exemplary embodiment of the present disclosure.

FIG. 3 is a graph depicting a stall line and an operation line for the exemplary gas turbine engine of FIG. 2 while extracting a relatively high amount of electrical power from the exemplary gas turbine engine.

FIG. 4 is a graph depicting a stall line and an operation line for the exemplary gas turbine engine of FIG. 2 while extracting little or no electrical power from the exemplary gas turbine engine.

FIG. 5 is a flow diagram of a method for controlling a gas turbine engine in accordance with an exemplary aspect of the present disclosure.

FIG. 6 a flow diagram of a method for controlling a gas turbine engine in accordance with another exemplary aspect of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

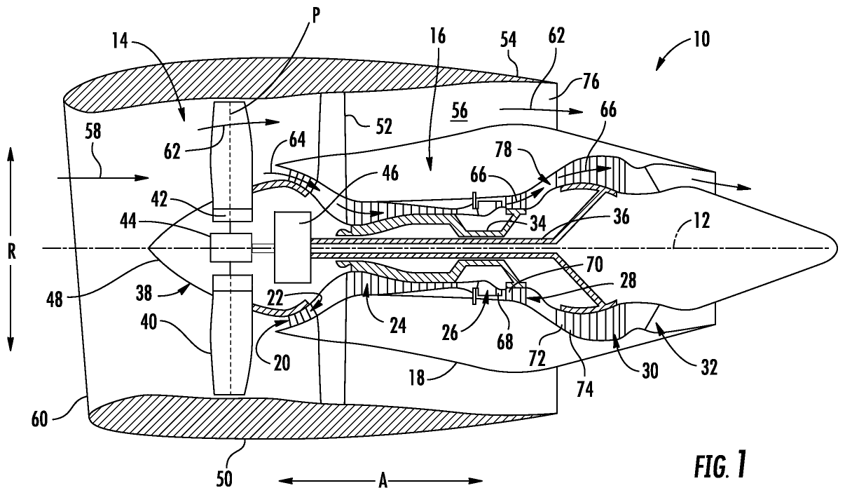

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine 10, referred to herein as “turbofan engine 10.” As shown in FIG. 1, the turbofan engine 10 defines an axial direction A (extending parallel to a longitudinal centerline 12 provided for reference) and a radial direction R. In general, the turbofan 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22.

For the embodiment depicted, the fan section 14 includes a variable pitch fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable actuation member 44 configured to collectively vary the pitch of the fan blades 40 in unison. The fan blades 40, disk 42, and actuation member 44 are together rotatable about the longitudinal axis 12 by LP shaft 36 across a power gear box 46. The power gear box 46 includes a plurality of gears for stepping down the rotational speed of the LP shaft 36 to a more efficient rotational fan speed.

Referring still to the exemplary embodiment of FIG. 1, the disk 42 is covered by rotatable front hub 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. It should be appreciated that the nacelle 50 may be configured to be supported relative to the core turbine engine 16 by a plurality of circumferentially-spaced outlet guide vanes 52. Moreover, a downstream section 54 of the nacelle 50 may extend over an outer portion of the core turbine engine 16 so as to define a bypass airflow passage 56 therebetween.

During operation of the turbofan engine 10, a volume of air 58 enters the turbofan 10 through an associated inlet 60 of the nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the core turbine engine 16.

It should be appreciated, however, that the exemplary turbofan engine 10 depicted in FIG. 1 is by way of example only, and that in other exemplary embodiments, the turbofan engine 10 may be any other suitable gas turbine engine, such as one or more of the following aeronautical gas turbine engines: a turboprop engine, turbojet engine, turboshaft engine, etc.

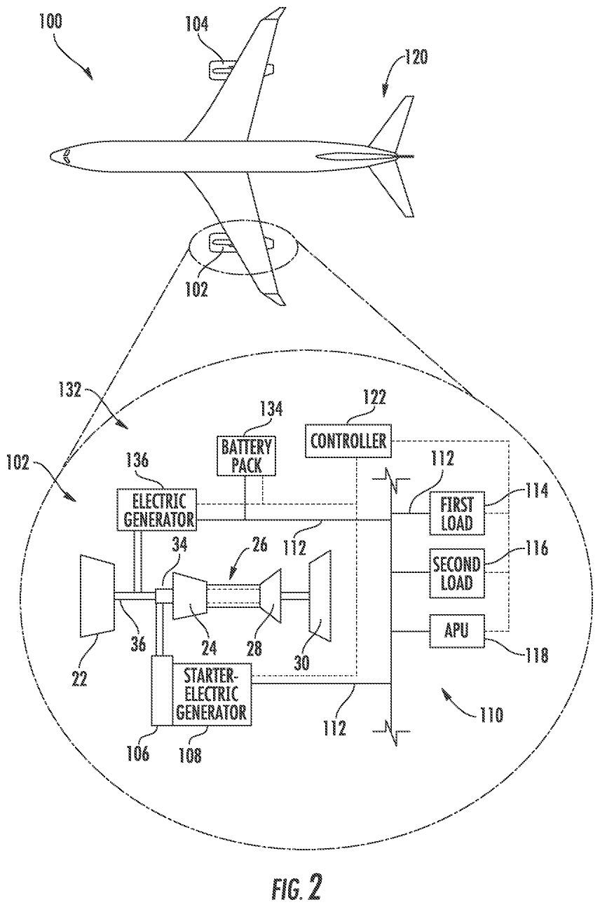

Referring now to FIG. 2, a simplified, schematic view is provided of an aircraft 100 including a pair of turbofan engines in accordance with various aspects of the present disclosure. Specifically, the exemplary aircraft 100 depicted includes a first turbofan engine 102 and a second turbofan engine 104. It should be appreciated, however, that the exemplary aircraft 100 depicted is provided by way of example only and that in other exemplary embodiments, the aircraft 100 may include any other suitable number and/or configuration of engines.

Additionally, the first and/or second turbofan engines 102, 104 may each be configured in substantially the same manner as the exemplary turbofan engine 10 of FIG. 1. Accordingly, the same or similar numbering of components may refer to the same or similar parts. For example, as shown in the close-up, simplified, schematic view of the first turbofan engine 102 in FIG. 2, the exemplary first turbofan engine 102 includes a compressor section (including an LP compressor 22 and an HP compressor 24), a combustion section 26, and a turbine section (including an HP turbine 28 and an LP turbine 30). The HP compressor 24 is mechanically coupled to the HP turbine 28 via an HP shaft 34 (depicted in phantom through the combustion section 26), and the LP compressor 22 is mechanically coupled to the LP turbine 30 via an LP shaft 36. The exemplary first turbofan engine 102 may additionally include other aspects similar to the exemplary turbofan engine 10 described above with reference to FIG. 1

Moreover, the first turbofan engine 102 includes an electrical machine mechanically coupled to the HP shaft 34. More particularly, the first turbofan engine 102 includes an accessory gear box 106 mechanically coupled to the HP shaft 34, with the electrical machine mechanically coupled to the accessory gear box 106. The electrical machine, for the embodiment depicted, is a main starter-electric generator 108. The starter-electric generator 108 may be configured to start the turbofan engine 102 by transforming electrical power to mechanical work, and applying such mechanical work to the HP shaft 34 through the accessory gear box 106. For example, the starter-electric generator 108 may rotate the HP shaft 34 until certain components of the turbofan engine 102 are rotating at idle speeds. Once such components of the turbofan engine 102 are rotating at idle speeds, fuel may be provided to the combustion section 26, and the combustion of such fuel in the combustion section 26—generating combustion gases—may take over driving the turbofan engine 102.

By contrast, however, during operation of the turbofan engine 102, the starter-electric generator 108 may transform mechanical work from the HP shaft 34 to electrical power. The electrical power extracted from the HP shaft 34 of the turbofan engine 102 and generated by the starter-electric generator 108 may then be used to power certain components of the turbofan engine 102 and/or the aircraft 100. For example, the exemplary main starter-electric generator 108 is configured for electrical communication with a power distribution bus 110 of the turbofan engine 102 and/or of the aircraft 100. Specifically, for the embodiment depicted in FIG. 2, the main starter-electric generator 108 is in electrical communication with the power distribution bus 110 via one or more electrical lines 112.

The power distribution bus 110 may distribute electrical power from one or more power sources to the various systems of the turbofan engine 102 and/or the aircraft 100. For the embodiment of FIG. 2, the power distribution bus 110 is in electrical communication with a first load 114 and a second load 116. The first load 114 may be, e.g., an environmental control system of the aircraft 100. The environmental control system may regulate an internal temperature and pressure of a cabin of the aircraft 100. Additionally, the second load 116 may be one or more electrical systems of the turbofan engine 102 and/or the aircraft 100. It should be appreciated, of course, that in other exemplary embodiments any other suitable loads may additionally or alternatively be in electrical communication with the power distribution bus 110.

Further, an auxiliary power unit 118 is also provided in electrical communication with the power distribution bus 110. The auxiliary power unit 118 may include an electric generator and a dedicated turbine engine, each located at an aft end 120 of the aircraft 100. The electric generator may be driven by the dedicated turbine engine to produce electrical power. The auxiliary power unit 118 may provide such electrical power to the power distribution bus 110 when, for example, the turbofan engine 102 is not operating. For example, the auxiliary power unit 118 may provide electrical power to the power distribution bus 110 when the aircraft 100 is parked, or in the event of a failure of the turbofan engine 102 during flight of the aircraft 100. In at least certain exemplary embodiments, the auxiliary power unit 118 may provide electrical power through the power distribution bus 110 to the starter-electric generator 108 during startup such that the starter-electric generator 108 may start the turbofan engine 102 in the manner described above.

As will be discussed in greater detail below, the turbofan engine 102 is configured to integrate engine control and electrical power generation. Specifically, the turbofan engine 102 includes a controller 122 operably connected to the starter-electric generator 108 as well as to the various loads on the power distribution bus 110. The controller 122 may be a controller dedicated to the turbofan engine 102, or alternatively may be integrated into a main controller for the aircraft 100. For the embodiment depicted, the controller 122 is configured to, e.g., determine a desired amount of thrust to be produced from the turbofan engine 102 as well as a desired amount of electrical power to be generated from the turbofan engine 102, or more particularly from the starter-electric generator 108 of the turbofan engine 102. In light of these determinations, the controller 122 is configured to operate the turbofan engine 102 in order to achieve the desired amount of thrust, and/or in order to achieve the desired amount of thrust production more quickly. With such a mode of operation, the controller 122 may be configured to reduce an amount of electrical power generated by the starter-electric generator 108 to an amount below the desired amount in order to facilitate such thrust production from the turbofan engine 102. For example, in certain exemplary embodiments, the controller 122 may be configured to reduce an amount of electrical power generated by the starter-electric generator 108 by at least about ten percent (10%) of the desired amount to facilitate the thrust production from the turbofan engine 102. Alternatively, however, in other exemplary embodiments, the controller 122 may be configured to reduce an amount of electrical power generated by the starter-electric generator 108 by at least about fifteen percent (15%) of the desired amount, at least about twenty percent (20%) of the desired amount, at least about thirty percent (30%) of the desired amount, at least about fifty percent (50%) of the desired amount, or at least about seventy-five percent (75%) of the desired amount. The maximum amount of reduction in the electrical power generated by the starter-electric generator 108 may be a function of a minimum amount of electrical power required to run certain critical electronic components of the turbofan engine 102 and/or the aircraft 100.

Accordingly, the controller 122 of the turbofan engine 102, at least in certain exemplary aspects, determines a thrust requirement and subordinates electrical power generation needs to ensure such thrust requirement is met, or met more quickly.

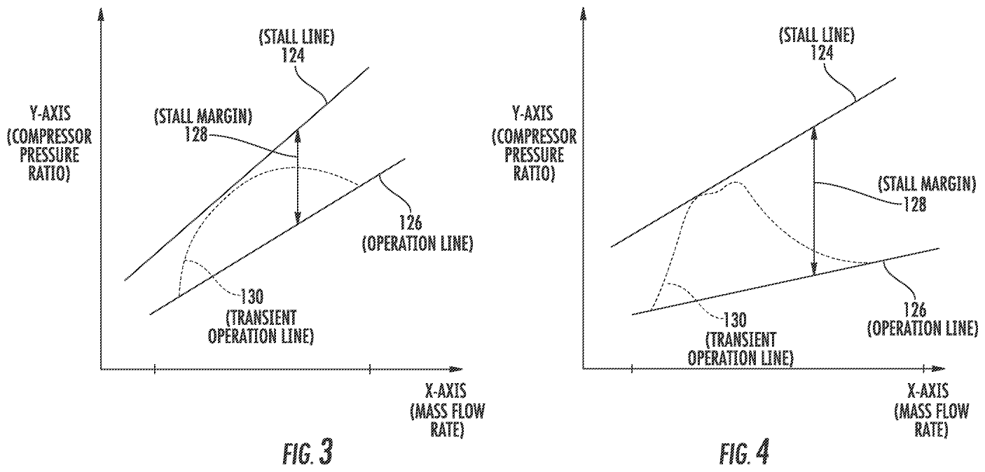

With reference now also to FIGS. 3 and 4, a stall line 124 for the exemplary turbofan engine 102 is depicted graphically. Specifically, FIG. 3 depicts the stall line 124 for the exemplary turbofan engine 102 as well as an operation line 126 for the turbofan engine 102 while the turbofan engine 102 is extracting a relatively high amount of electrical power using the starter-electric generator 108. By contrast, FIG. 4 depicts the stall line 124 for the exemplary turbofan engine 102 along with an operation line 126 for the turbofan engine 102 while the turbofan engine 102 is extracting little or no electrical power using the starter-electric generator 108.

For FIGS. 3 and 4, the stall line 124 is defined as a maximum ratio of a compressor pressure ratio (y-axis) to a compressor mass flow rate (x-axis) that will consistently allow for stable airflow through the turbofan engine 102. The compressor pressure ratio is generally defined as a ratio of a stagnation pressure at a forward end (i.e., an upstream end) of the compressor section to a pressure at an aft end (i.e., a downstream end) of the compressor section. Additionally, the compressor mass flow rate is generally defined as a mass of the air flowing through the compressor section per unit of time. Further, the operation line 126 indicates the ratio of the compressor pressure ratio to the compressor mass flow rate for the turbofan engine 102 during steady state operation of the turbofan engine 102 for a variety of compressor speeds.

If the ratio of the compressor pressure ratio to compressor mass flow rate exceeds the stall line 124, it is more likely that the compressor will stall or surge. Accordingly, in order to ensure stable airflow through the turbofan engine 102, the turbofan engine 102 is designed and/or operated such that the operation line 126 falls below the stall line 124. Defined between the operation line 126 of the turbofan engine 102 and the stall line 124 of the turbofan engine 102 is the stall margin 128. As shown, the stall margin 128 is increased when an amount of power extracted from the turbofan engine 102 through the starter-electric generator 108 is reduced. For example, the stall margin 128 is greater in FIG. 4 wherein little or no electrical power is being extracted from the turbofan engine 102 through the starter-electric generator 108, as compared to the stall margin 128 in FIG. 3, wherein a relatively high amount of electrical power is being extracted from the turbofan engine 102 through the starter-electric generator 108.

Moreover, when the turbofan engine 102 is operated in transient conditions, e.g., when a core speed of the turbofan engine 102 is increased or decreased, the ratio of the compressor pressure ratio to compressor mass flow rate can vary from the operation line 126 of the turbofan engine 102. The core speed of the turbofan engine 102 may refer to a rotational speed of the HP shaft 34. As the core speed of the turbofan engine 102 increases, a velocity and/or mass flow rate of the combustion gasses through the turbine section and nozzle 32 (see FIG. 1) can also increase, which can produce more thrust.

Accordingly, aspects of the present disclosure may reduce an amount of electrical power extracted from the turbofan engine 102 through the starter-electric generator 108 to increase the stall margin 128 for the turbofan engine 102 and allow for greater variations from the operation line 126 during such transient engine conditions. A turbofan engine 102 operated in such a manner may thus be capable of, e.g., increasing its core speed more quickly (i.e., accelerating), and/or reaching a greater core speed (and thus producing more thrust). For example, FIG. 3 depicts a transient operation line 130 (in phantom) for the turbofan engine 102 while a desired amount of electrical power is extracted from the turbofan engine 102, and FIG. 4 depicts a transient operation line 130 (in phantom) for the turbofan engine 102 while less than a desired amount of electrical power is extracted from the turbofan engine 102. The increased stall margin 128 resulting from a decrease in the amount of electrical power extracted from the turbofan engine 102, as depicted in FIG. 4, allows for the turbofan engine 102 to achieve increased core speeds more quickly, and thus to produce an increased amount of thrust more quickly. For example, with the increased stall margin 128, the turbofan engine 102 may increase its compressor pressure ratio more quickly than is allowed with the standard stall margin 128.

Referring back to FIG. 2, the exemplary turbofan engine 102 depicted includes additional elements to provide auxiliary power when, e.g., the controller 122 reduces an amount of electrical power extracted from the turbofan engine 102 through the starter-electric generator 108. More specifically, the exemplary turbofan engine 102 further includes an auxiliary power supply 132 also configured for electrical communication with the power distribution bus 110. The auxiliary power supply 132 may be configured to provide electrical power to the power distribution bus 110 when the amount of power generated by the starter-electric generator 108 is reduced to facilitate a desired amount of thrust production by the turbofan engine 102.

For the embodiment depicted, the auxiliary power supply 132 includes a battery pack 134 configured for electrical communication with the power distribution bus 110 and an auxiliary electric generator 136 also configured for electrical communication with the power distribution bus 110. For the embodiment depicted, the auxiliary power supply 132, including the battery pack 134 and auxiliary electric generator 136, is in electrical communication with power distribution bus 110 via the one or more electrical lines 112.

The battery pack 134 may be any suitable battery pack 134 sufficient for carrying an electrical load of the aircraft 100 and/or turbofan engine 102. For example, the battery pack 134 may be configured to provide electrical power at a rate of at least about 150 kW, at least about 200 kW, at least about 250 kW, at least about 300 kW, or at least about 350 kW. Additionally, the battery pack 134 may be configured to provide such electrical power for at least about ten seconds, at least about thirty seconds, at least about two minutes, at least about five minutes, or at least about ten minutes. In other exemplary embodiments, however, the battery pack 134 may be configured to provide electrical power at any other suitable rate for any other suitable time period. Additionally, the battery pack 134 may incorporate any suitable battery technology. For example, the battery pack 134 may include one or more of the following chemistries: lithium iron phosphate, lithium ion, alkaline, or zinc-based. It should be appreciated, that as used herein, terms of approximation, such as “about” or “approximately,” refer to being within a ten percent (10%) margin of error.

As depicted, the battery pack 134 is in operable communication with the controller 122. In certain embodiments, the controller 122 may be configured to operate the battery pack 134 to provide electrical power from the battery pack 134 to the power distribution bus 110 when the amount of electrical power generated by the starter-electric generator 108 has been reduced to an amount below a desired amount to facilitate thrust production by the turbofan engine 102. For example, the controller 122 may be configured to operate the battery pack 134 to provide electrical power from the battery pack 134 to the power distribution bus 110 when the turbofan engine 102 is operated under certain transient engine conditions.

As previously stated, the exemplary auxiliary power supply 132 also includes the auxiliary electric generator 136. The auxiliary electric generator 136 is driven by the one or more shafts of the turbofan engine 102. More particularly, for the embodiment depicted, the auxiliary electric generator 136 is driven by the LP shaft 36 of the turbofan engine 102. Accordingly, for the embodiment depicted the turbofan engine 102 includes the main starter-electric generator 108 mechanically coupled to and driven by the HP shaft 34 and the auxiliary electric generator 136 mechanically coupled to and driven by the LP shaft 36.

The auxiliary electric generator 136 is operably connected to the controller 122. The controller 122 may additionally, or alternatively, be configured to operate the auxiliary electric generator 136 to provide power from the auxiliary electric generator 136 to the power distribution bus 110 when the turbofan engine 102 is operated under transient engine conditions. Particularly, the controller 122 may be configured to operate the auxiliary electric generator 136 to provide power from the auxiliary electric generator 136 to the power distribution bus 110 when an amount of power extracted from the HP shaft 34 using the starter-electric generator 108 is reduced to accommodate a desired amount of thrust production from the turbofan engine 102.

Additionally, or alternatively, in certain exemplary aspects the controller 122 may be configured to provide power from the auxiliary electric generator 136, through the power distribution bus 110, through the starter-electric generator 108, and back to the core 16 of the turbofan engine 102. More particularly, the controller 122 may be configured to provide power from the auxiliary electric generator 136, through the power distribution bus 110 and starter-electric generator 108 to the HP shaft 34. For example, the controller 122 may be configured to provide power in such a manner to the HP shaft 34 during low-speed idle engine conditions. When the aircraft 100 is descending, for example, it may be beneficial to operate the turbofan engine 102 at a relatively low core speed (e.g., at an idle speed), such that little or no thrust is produced by the turbofan engine 102. In order to further reduce the compressor mass flow rate (and thus reduce an amount of thrust provided), the amount of electrical power extracted by the starter-electric generator 108 may need to be minimized to increase the stall margin 128 (see FIG. 4). The auxiliary electric generator 136 may thus be used to make up the deficit of electrical power production. Further, if the auxiliary electric generator 136 includes additional electrical power generation capacity on top of the deficit, such additional electric power may be provided, in the manner described above, through the power distribution bus 110 and starter-electric generator 108 back to the HP shaft 34 of the turbofan engine 102. Such may allow for less fuel usage and thus greater efficiency for the turbofan engine 102.

It should be appreciated, however, that the exemplary embodiment described above with reference to FIG. 2 is provided by way of example only. For example, in certain exemplary embodiments, the turbofan engine 102 may not include one or more aspects of the auxiliary power supply 132 described herein. For example in certain embodiments, the turbofan engine 102 may not include at least one of the battery system 134 or the auxiliary electric generator 136. Further, in still other embodiments, the turbofan engine 102 may not include the auxiliary power supply 132 altogether.

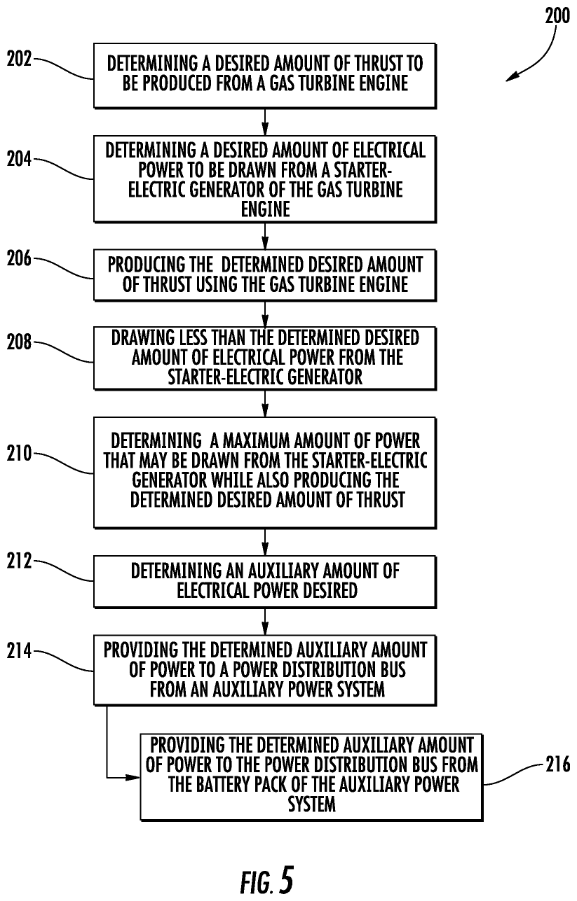

Referring now to FIG. 5, a flow diagram is provided of a method (200) for operating a multi-shaft gas turbine engine. In certain exemplary aspects, the multi-shaft gas turbine engine may be the first turbofan engine 102 incorporated into the aircraft 100 described above with reference to FIG. 2. Accordingly, in certain exemplary aspects, the gas turbine engine may include an electrical machine, and the electrical machine may be a starter-electric generator driven by a high pressure shaft of the gas turbine engine.

As depicted, the exemplary method (200) includes at (202) determining a desired amount of thrust to be produced from the gas turbine engine. Such a determination at (202) may be made by a controller of the gas turbine engine and/or the aircraft in response to, e.g., a user input. For example, the user may increase a throttle of the aircraft indicating to the controller that an increased thrust production is desired from the gas turbine engine.

The exemplary method (200) additionally includes at (204) determining a desired amount of electrical power to be generated from the starter-electric generator of the gas turbine engine. For example, determining at (204) the desired amount of electrical power to be generated from the starter-electric generator of the gas turbine engine may include determining an amount of electrical power required to operate one or more loads in electrical communication with a power distribution bus of the gas turbine engine and/or the aircraft. For example, the determination made at (204) may include determining an amount of power required to fully operate an environmental controls system of the aircraft and various other electrical systems of the gas turbine engine and/or aircraft.

Referring still to FIG. 5, the exemplary method (200) additionally includes at (206) producing the desired amount of thrust determined at (202) using the gas turbine engine and at (208) producing less than the desired amount of electrical power determined at (204) using the starter-electric generator. Notably, for the exemplary method (200) of FIG. 5, producing less than the desired amount of electrical power at (208) allows the gas turbine engine to produce the desired amount of thrust at (206), or to produce the desired amount of thrust at (206) more quickly. For example, producing less than the desired amount of electrical power at (208) may include in certain exemplary aspects producing less than the amount of power required to fully operate the environmental controls system and/or the various other electrical systems of the gas turbine engine and aircraft.

Accordingly, for the exemplary method (200) of FIG. 5, the gas turbine engine determines a thrust requirement and subordinates any electrical power generation needs to ensure such thrust requirement may be met, or may be met more quickly. As discussed above with reference to FIGS. 3 and 4, the ability to produce the desired amount of thrust, or to produce the desired amount of thrust more quickly, is due to an increased stall margin resulting from the reduction in the electrical power produced by the starter-electric generator by extracting energy from the HP shaft.

Notably, however, for the exemplary aspect depicted in FIG. 5, the method (200) includes elements for supplementing the reduction in electrical power produced by the starter-electric generator of the gas turbine engine. More specifically, the exemplary method (200) additionally includes at (210) determining a maximum amount of power that the gas turbine engine is capable of producing using the starter-electric generator while also producing the desired amount of thrust at (206) within a desired amount of time. From the determination made at (210), the exemplary method (200) includes determining at (212) an auxiliary amount of electrical power desired. Specifically, the method (200) includes at (212) determining an auxiliary amount of electrical power desired by subtracting the determined maximum amount of power at (210) that may be produced while also producing the desired amount of thrust from the determined desired amount of electrical power at (204) to be generated.

Referring still to FIG. 5, the exemplary method also includes at (214) providing the auxiliary amount of power determined at (212) to a power distribution bus from an auxiliary power system. The power distribution bus may be a power distribution bus of the aircraft and/or of the gas turbine engine. Accordingly, the starter-electric generator of the gas turbine engine may also be in electrical communication with the power distribution bus. For the exemplary aspect depicted, the auxiliary power system includes a battery pack, and providing at (214) the auxiliary amount of power determined at (212) to the power distribution bus includes at (216) providing the determined auxiliary amount of power to the power distribution bus from the battery pack of the auxiliary power system.

Notably, in certain exemplary aspects, the method (200) may operate during transient engine conditions of the gas turbine engine. Additionally, reducing the amount of power generated using the starter-electric generator of the gas turbine engine, and instead providing such power from the battery pack of the auxiliary power system, allows for an increased stall margin between the stall line of the gas turbine engine and the operating line of the gas turbine engine. Accordingly, such a reduction in power extracted from the gas turbine engine using the starter-electric generator may better accommodate the transient engine conditions and allow for, e.g., increased acceleration of the gas turbine engine, and/or a higher maximum amount of thrust to be provided.

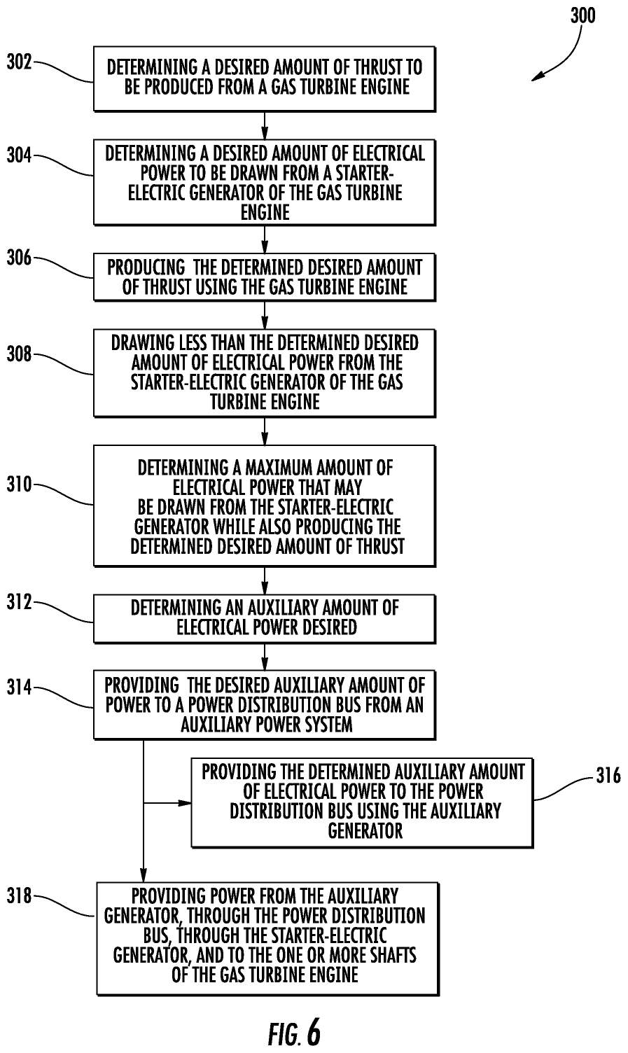

Referring now to FIG. 6, a method for operating a multishaft gas turbine engine in accordance with another exemplary aspect of the present disclosure is provided. The exemplary method (300) may be similar to the exemplary method (200) described above with reference to FIG. 5. For example, the exemplary method (300) may include at (302) determining a desired amount of thrust to be produced from the gas turbine engine, and at (304) determining a desired amount of electrical power to be generated from the electric generator of the gas turbine engine. Additionally, the exemplary method (300) includes at (306) producing the desired amount of thrust determined at (302) using the gas turbine engine and at (308) producing less than the desired amount of electrical power determined at (304) using the starter-electric generator of the gas turbine engine to allow the gas turbine engine to produce the desired amount of thrust, or to produce the desired amount of thrust more quickly.

Notably, however, as with the method (200) depicted in FIG. 5, the method (300) includes elements for supplementing the reduction in electrical power produced by the starter-electric generator of the gas turbine engine. Specifically, the exemplary method (300) additionally includes at (310) determining a maximum amount of electrical power that the gas turbine engine is capable of producing using the starter-electric generator while also producing the desired amount of thrust determined at (302). At (312) the exemplary method (300) includes determining an auxiliary amount of electrical power desired based on the determined desired amount of electrical power to be generated at (304) and the determined maximum amount of power that may be produced while also producing the desired amount of thrust using the gas turbine engine at (310).

Referring still to FIG. 6, the exemplary method (300) also includes at (314) providing the determined auxiliary amount of power to a power distribution bus from an auxiliary power system. As with the exemplary method (200) of FIG. 5, the power distribution bus may be a power distribution bus of the gas turbine engine and/or of the aircraft including the gas turbine engine. Accordingly, the starter-electric generator of the gas turbine engine may also be in electrical communication with the power description bus.

For the embodiment of FIG. 6, however, the starter-electric generator is a main electric generator, and the auxiliary power system includes an auxiliary electric generator also driven by the one or more shafts of the gas turbine engine. More particularly, for the exemplary aspect of FIG. 6 the one or more shafts the gas turbine engine include a high pressure shaft and a low pressure shaft. The main electric generator is driven by the high pressure shaft and the auxiliary electric generator is driven by the low pressure shaft. Accordingly, for the exemplary method (300) of FIG. 6, providing the determined auxiliary amount of power to the power distribution bus at (314) includes providing at (316) the determined auxiliary amount of electrical power to the power distribution bus using the auxiliary generator.

Furthermore, the exemplary method (300) includes at (318) providing power from the auxiliary generator, through the power distribution bus, through the starter-electric generator, and to the one or more shafts of the gas turbine engine (specifically to the high pressure shaft of the gas turbine engine) to add power to and drive such shaft. Notably, providing power from the auxiliary generator at (318) through the power distribution bus and starter-electric generator to the high pressure shaft may be in response to a determination that the auxiliary generator has additional electric generating capacity. Providing power from the auxiliary generator at (318) to the high pressure shaft may allow for lower idle speeds of the gas turbine engine, such as during a descent of the aircraft including the gas turbine engine, and may allow for an increased fuel efficiency of the gas turbine engine.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method for operating a multi-shaft aeronautical gas turbine engine,
wherein the gas turbine comprises a compressor section and an electrical machine,
wherein the electrical machine comprises a starter-electric generator driven by at least one of the shafts of the gas turbine engine,
wherein the gas turbine engine defines a compressor pressure ratio that is a ratio of a stagnation pressure at an upstream end of the compressor section to a pressure at a downstream end of the compressor section,
wherein the gas turbine engine defines a compressor mass flow rate that is rate at which a mass of air flows through the compressor section,
wherein the gas turbine engine defines an operation line that is a plot of the compressor pressure ratio against the compressor mass flow rate during steady state operation of the turbofan engine,
wherein the gas turbine engine defines a stall line that is a plot of the compressor pressure ratio against the compressor mass flow rate that indicates a highest compressor pressure ratio that still consistently allows for stable airflow through the turbofan engine,
wherein the stall margin is a margin between the stall line and the operation line,
wherein the method comprises:
determining a desired amount of thrust to be produced from the gas turbine engine;
determining a desired amount of electrical power to be drawn from the starter-electric generator of the gas turbine engine;
producing the desired amount of thrust using the gas turbine engine;
drawing less than the desired amount of electrical power from the starter-electric generator of the gas turbine engine to allow the gas turbine engine to generate an increased stall margin; and
operating the gas turbine engine at a transient engine condition in which the gas turbine is operated within the increased stall margin closer to the stall line than the operation line.

2. The method of claim 1,
wherein determining the desired amount of electrical power to be drawn includes determining an amount of power required to fully operate an environmental controls system, and
wherein drawing less than the desired amount of electrical power includes drawing less than the amount of power required to fully operate the environmental controls system.

3. The method of claim 1, further comprising:
determining a maximum amount of electrical power that may be drawn from the starter-electric generator while also producing the desired amount of thrust.

4. The method of claim 3, further comprising:
determining an auxiliary amount of electrical power desired based on the determined desired amount of electrical power to be drawn and the determined maximum amount of power that that may be drawn from the starter-electric generator while also producing the desired amount of thrust.

5. The method of claim 4, further comprising:
providing the determined auxiliary amount of electrical power to a power distribution bus from an auxiliary power system, wherein the starter-electric generator of the gas turbine engine is also in electrical communication with the power distribution bus.

6. The method of claim 5, wherein the auxiliary power system includes an energy storage device.

7. The method of claim 6, wherein providing the determined auxiliary amount of power to the power distribution bus includes providing the determined auxiliary amount of power to the power distribution bus from the battery pack of the auxiliary power system while operating the gas turbine engine under transient engine conditions.

8. The method of claim 5,
wherein the starter-electric generator of the gas turbine engine is a main starter-electric generator, and
wherein the auxiliary power system includes an auxiliary electric generator driven by the one or more shafts of the gas turbine engine.

9. The method of claim 8, wherein providing the determined auxiliary amount of electrical power to the power distribution bus includes providing the determined auxiliary amount of electrical power to the power distribution bus from the auxiliary electric generator of the auxiliary power system.

10. The method of claim 8, further comprising:
providing power from the auxiliary electric generator, through the power distribution bus, through the starter-electric generator of the gas turbine engine, and to the one or more shafts of the gas turbine engine.

11. The method of claim 8,
wherein the one or more shafts of the gas turbine engine include a high pressure shaft and a low pressure shaft,
wherein the main starter-electric generator is driven by the high pressure shaft, and
wherein the auxiliary electric generator is driven by the low pressure shaft.

12. An aeronautical gas turbine engine comprising:
a compressor section;
a combustion section located downstream of the compressor section;
a turbine section located downstream of the combustion section, the turbine section mechanically coupled to the compressor section by one or more shafts;
an electrical machine in mechanical communication with the one or more shafts, the electrical machine including a starter-electric generator for generating electrical power; and
a controller operably connected to the starter-electric generator,
wherein the gas turbine engine defines a compressor pressure ratio that is a ratio of a stagnation pressure at an upstream end of the compressor section to a pressure at a downstream end of the compressor section,
wherein the gas turbine engine defines a compressor mass flow rate that is rate at which a mass of air flows through the compressor section,
wherein the gas turbine engine defines an operation line that is a plot of the compressor pressure ratio against the compressor mass flow rate during steady state operation of the turbofan engine,
wherein the gas turbine engine defines a stall line that is a plot of the compressor pressure ratio against the compressor mass flow rate that indicates a highest compressor pressure ratio that still consistently allows for stable airflow through the turbofan engine,
wherein the stall margin is a margin between the stall line and the operation line,
wherein the controller is configured to reduce an amount of electrical power drawn from the starter-electric generator to an amount below a desired amount to be drawn in order to generate an increased stall margin, and
wherein the controller is configured to operate the gas turbine engine at a transient engine condition in which the gas turbine is operated within the increased stall margin closer to the stall line than the operation line.

13. The gas turbine engine of claim 12, wherein the starter-electric generator is configured for electrical communication with a power distribution bus, and wherein the gas turbine engine further includes
an auxiliary power supply also configured for electrical communication with the power distribution bus, wherein the controller is further configured to provide electrical power to the power distribution bus from the auxiliary power supply when the amount of power drawn from the starter-electric generator is reduced to facilitate a desired amount of thrust production by the gas turbine engine.

14. The gas turbine engine of claim 13, wherein the auxiliary power supply includes an energy storage device.

15. The gas turbine engine of claim 14, wherein the controller is configured to reduce the amount of electric power drawn from the starter-electric generator to an amount below the desired amount when the gas turbine engine is operated under transient engine conditions.

16. The gas turbine engine of claim 12,
wherein the starter-electric generator is in electrical communication with a power distribution bus of the gas turbine engine, and
wherein the gas turbine engine further includes:
an auxiliary power supply also in electrical communication with the power distribution bus of the gas turbine engine, wherein the starter-electric generator is a main starter-electric generator, and wherein the auxiliary power supply includes an auxiliary electric generator driven by the one or more shafts of the gas turbine engine.

17. The gas turbine engine of claim 16,
wherein the one or more shafts include a high pressure shaft and a low pressure shaft,
wherein the main starter-electric generator is driven by the high pressure shaft, and
wherein the auxiliary electric generator is driven by the low pressure shaft.

18. The gas turbine engine of claim 16,
wherein the controller is operably connected to the auxiliary electric generator, and
wherein the controller is configured to provide power from the auxiliary electric generator, through the power distribution bus, through the electrical machine of the gas turbine engine, and to the one or more shafts of the gas turbine engine.

19. The gas turbine engine of claim 16,
wherein the controller is operably connected to the auxiliary electric generator, and
wherein the controller is configured to provide power from the auxiliary electric generator to the power distribution bus.

20. The gas turbine engine of claim 12, wherein the controller configured to reduce the amount of electrical power drawn from the starter-electric generator by at least about ten percent (10%) of a desired amount to facilitate the thrust production from the gas turbine engine.
